(19) United States
(12) Patent Application Publication
(10) Pub. No.: US 2024/0202441 A1
(43) Pub. Date: Jun. 20, 2024

(54) COMMUNICATION SYSTEM FOR TEXT-BASED COMMUNICATION

(71) Applicant: Frequentis AG, Wien (AT)

(72) Inventor: Richard Prinz, Wien (AT)

(21) Appl. No.: 18/541,231

(22) Filed: Dec. 15, 2023

(30) Foreign Application Priority Data
Dec. 15, 2022 (AT) A50961/2022

(51) Int. Cl. G06F 40/279; G06F 3/0484

(52) U.S. Cl. CPC G06F 40/279; G06F 3/0484

(57) ABSTRACT

A communication system for text-based communication contains a communication unit having a communication interface for receiving chat text messages from an additional communication unit and to send incoming chat text messages to the additional communication unit. An input unit allows a first user to input chat text messages, and a display unit, on which chat text messages received are displayed as chat. The additional communication unit is configured similar to the communications unit. A chat application is invoked from the additional communication unit, wherein chat text messages are issued via the chat application to the communication unit and the chat application displays graphical user interfaces on the additional communication unit. An analysis entity is configured to analyze the chat text messages and to add metadata to the input chat text message. The chat application is configured to display a graphical user interface corresponding to the metadata upon receiving the metadata.

### CROSS-REFERENCE TO RELATED APPLICATION

This application claims the priority, under 35 U.S.C. § 119 of Austrian Patent Application AT A50961/2022, filed Dec. 15, 2022; the prior application is herewith incorporated by reference in its entirety.

### FIELD AND BACKGROUND OF THE INVENTION

The invention relates to a communication system for text-based communication according to the independent claim.

New emergency call formats such as NG112 enable users or persons issuing an emergency call to communicate with a control center, inter alia, via text, which considerably simplifies communication with the control center, for example, for hearing-impaired people. This type of emergency call is also advantageous in situations where a conventional, emergency telephone call is not possible, for example because the user must make as little sound as possible. Examples of this are situations in connection with domestic violence (silent emergency call) or, for example, during a violent rampage. However, a text-based emergency call takes longer than a telephone emergency call due to the text input, which is usually performed on a device with a touch display. Furthermore, the text input is often inaccurate or incorrect especially in stressful situations. This makes it difficult for the control center to obtain the necessary information from the caller quickly in order to enable an assessment of the emergency situation and appropriate actions to be put in place.

However, the problem of inaccurate, incorrect text-based communication when a user is in a stressful situation or is not easily able, or only very slowly, to use the touch display as an input device is not limited to the context of issuing text-based emergency calls. In general, this problem exists in the context of text chats, for example, when information is to be collected to provide an appropriate response or to take appropriate action, such as in connection with service and support provision.

### SUMMARY OF THE INVENTION

The object of the invention, therefore, is to remedy the aforementioned disadvantages and to provide a communication system for text-based communication which makes it possible to obtain accurate information from a user via text-based communication even if the user is experiencing high levels of stress or anxiety, or has difficulty using the input medium they are using to write text messages.

The invention achieves this object with a communication system for text-based communication according to the independent claim. According to the invention, it is provided that the communication system contains:
a communication unit, having:
   at least one communication interface, which is designed to receive chat text messages from an additional communication unit and to send incoming chat text messages to an additional communication unit,
   an input unit that allows a first user to input chat text messages, and
   a display unit, on which chat text messages received from the communication interface and chat text messages input via the input unit can be displayed as chat,
an additional communication unit, containing:
   at least one additional communication interface, which is designed to receive chat text messages from the communication unit and to send incoming chat text messages,
   a further input unit that allows a second user to input chat text messages,
   an additional display unit, on which chat text messages received from the additional communication interface and chat text messages input via the additional input unit can be displayed as chat, and
   wherein a chat application can be invoked from the additional communication unit, wherein chat text messages can be issued to the communication unit via the chat application and wherein the chat application is designed to display graphical user interfaces in the chat on the additional communication unit, and
an analysis entity connected between the communication interface and the additional communication interface, wherein the analysis entity is designed to analyze the chat text messages input via the input unit and based on this analysis, to add metadata to the input chat text message before forwarding the messages to the additional communication interface, and wherein the chat application is designed to display a graphical user interface corresponding to the metadata upon receiving the metadata.

This design of a communication system according to the invention makes it advantageously possible to display context-dependent graphical user interfaces in the chat on the additional communication unit, i.e. in the chat of the second user, in order to shorten inputs and reduce errors in responses to the first user.

To achieve this, the analysis entity analyzes the chat text messages entered by the first user and, based on this analysis, adds metadata to the chat text messages, which enables the second user to view a (or, if appropriate, multiple) corresponding graphical user interface directly in the chat history, which enables the second user, for example, to respond in a targeted way to a question entered by the first user or to provide information requested by the first user, without the second user needing to enter lengthy chat text messages.

This advantageously ensures that even a second user who is in a stressful situation, is distracted or only able to input chat text messages slowly or incorrectly, can provide the necessary information which allows the first user, for example in an emergency situation or in situations where support and rescue services are to be provided, to respond correctly and take appropriate actions.

In the context of the invention, a communication unit is understood quite generally to mean an electronic device that can send and receive text messages and display the text messages for a user and allows a user to compose text messages. Often this will be some form of workstation, e.g. in an emergency control center or a call center, which is equipped with one or more corresponding interfaces, some form of screen and a tool for text input, but it can also be a portable terminal such as a mobile phone, smartphone, tablet or the like.

In the same way, in the context of the invention, an additional communication unit is to be understood to mean an electronic device that can send and receive text messages and display the text messages for a user and allows a user to compose text messages, as well as invoke chat applications. This is often a portable terminal such as a mobile phone, smartphone, tablet or the like. However, it can also be a form of workstation, e.g. in an emergency control center or a call center, which is equipped with one or more suitable interfaces, some form of screen and a tool for entering text.

Metadata in the context of the invention is understood to mean data that identify or describe graphical user interfaces. This can be metadata that serves as a kind of reference data, to uniquely identify one or more graphical user interfaces in a set of graphical user interfaces, or metadata that describes one or more graphical user interfaces in a way that a suitably designed chat application can create or display the graphical user interfaces based on the metadata.

In the context of the invention, an analysis entity is to be understood to mean an entity which has access to the chat text messages to be sent from the first user to the second user, that is, the chat text messages entered on the input unit and to be sent to the additional communication unit, and in a manner of speaking, can “read” them. The analysis entity analyzes the chat text messages textually, i.e. with regard to the content of the chat text messages—for example, by means of text recognition or artificial intelligence—in order to take further steps such as adding metadata based on this content examination or analysis.

In a communication system according to the invention, the addition of metadata can be achieved in a particularly simple manner if the analysis entity is designed to add metadata in the form of an identifier to the input chat text message before forwarding it to the additional communication interface. Wherein the identifier identifies a graphical user interface to be displayed by the chat application on the additional communication unit. Wherein in the chat application at least one graphical user interface is stored with its associated identifying identifier and wherein the chat application is designed to display at least one graphical user interface, the identifier of which corresponds to the received identifier, upon receiving an identifier.

An identifier is understood in the context of the invention to mean one or more characteristic features which is/are used for the unique identification of one or more graphical user interfaces, such as an alphanumeric string.

In this context, for a more flexible configuration, the analysis entity may be designed to add metadata in the form of a software component to the input chat text message before forwarding it to the additional communication interface, wherein the chat application is designed to display a corresponding graphical user interface upon receiving a software component.

In the context of the invention, a software component is understood to mean a type of program code, which can be transmitted together with a chat text message in order to be processed by the chat application upon receipt and displayed as a graphical user interface in the chat.

A communication system according to the invention can be designed to be particularly flexible to deploy if the additional communication unit is a mobile device, in particular a smartphone or tablet, and/or a chat application can be invoked from the communication unit, in particular if a chat application is installed on the communication unit. The chat application allows chat text messages to be issued to the additional communication unit and the chat application is preferably designed to display graphical user interfaces in the chat.

According to an advantageous variant of a communication system according to the invention for use in emergency communication, it can be provided that the text-based communication is a text-based emergency communication and that the communication unit is included in an operator's workstation for an emergency control center. The at least one communication interface is designed to receive emergency calls in the form of chat text messages from the additional communication unit and to send incoming chat text messages to the additional communication unit. The input unit allows an operator as a first user to input chat text messages to the second user, and chat text messages received from the communication interface and chat text messages input by the operator via the input unit can be displayed on the display unit.

In connection with text-based emergency communication, it can advantageously also be provided that the additional communication unit is a mobile device, in particular a smartphone or tablet. The chat application that can be invoked from the mobile device allows emergency calls in the form of a chat text message to be issued to the emergency control center and the mobile device contains at least one communication interface, which is designed to send emergency calls in the form of input chat text messages to the communication unit of the operator's workstation and to receive chat text messages from the communication unit of the operator's workstation.

A more targeted, improved retrieval of information can be achieved in the context of text-based communication if the analysis entity is designed to analyze the chat text messages input via the additional input unit and, based on this analysis, to select chat text messages stored in a memory of the analysis entity and/or in a memory of the first communication unit, in particular stored chat text messages from a question list, and/or metadata of graphical user interfaces to be displayed on the additional communication unit and to send the messages and metadata to the additional communication unit.

In this way, the facility is provided, for example, to process stored question lists automatically before the first user sends their questions in the form of chat text messages to the second user or in addition to the chat text messages created by the first user. This makes it easier for the first user to assess the situation and also reduces the workload on the first user.

The graphical user interfaces can be designed to be particularly simple and intuitive for the second user if the graphical user interfaces to be displayed by the chat application are GUI widgets.

A graphical user interface (GUI) widget is understood in the context of the invention to mean a graphical user interface with an interaction element such as a control or operating element, for example a button or a scroll bar.

In order to enable the first user to receive the appropriate information from the second user on a wide variety of questions or in different situations, while at the same time ensuring a simple, intuitive operation for the second user, it may be provided that the graphical user interfaces, in particular the GUI widgets, comprise one or more of the following elements:
a yes/no question,
a date and/or time selection,
a numeric range,
a more/less question,
a geographical map for manually selecting an item via the additional input unit,
a schematic representation of a person for selecting a body part via the additional input unit,
a picture,
a pictogram,
a video, and
an audio file for output via a speaker of the additional communication unit.

A secure and reliable way to communicate the second user's interaction with the graphical user interface in the chat on the additional communication unit to the first user or communication unit can be provided if the analysis entity is designed to detect an interaction with the graphical user interface performed by the second user in the chat via the additional input device and apply the following action to the interaction with the graphical user interface:
convert it into a chat text message corresponding to the interaction and transmit it to the communication unit, and/or
generate metadata corresponding to the interaction and transmit it to the communication unit.

An additional and/or alternative variant to communicate the interaction of the second user with the graphical user interface in the chat on the additional communication unit to the first user or the communication unit in a reliable manner can be provided if the chat application is designed to detect an interaction with the graphical user interface performed by the second user in the chat via the additional input device and to convert the interaction with the graphical user interface into a chat text message corresponding to the interaction and to transmit it to the communication unit.

In connection with the display of the information provided by the second user on the additional communication unit, it can be advantageously provided that the chat application of the communication unit is designed to process metadata transmitted by the analysis entity and to display it on the display unit for the first user.

In order to also provide to the first user or on the communication unit the facility to select graphical user interfaces, which are to be displayed to the second user or on the further communication unit, it can advantageously be provided that the communication unit and/or the analysis entity comprises a memory,
wherein graphical user interfaces, in particular GUI widgets, with their associated identifying metadata, in particular their identifier, are stored in the memory,
wherein when a chat text message is input by the first user via the input unit, graphical user interfaces stored in the memory can be selected, and
wherein the analysis entity is designed, when at least one graphical user interface is selected via the input unit, to add metadata to the input chat message corresponding to the at least one selected graphical user interface, in particular to add to the input chat text message an identifier and/or software component which corresponds to the selected graphical user interface.

If not only the content of the chat text messages transmitted to the second user is analyzed, but in addition the first user is also given the opportunity to actively select graphical user interfaces, the information gain can advantageously be maximized.

A particularly flexible configuration of a communication system according to the invention can be ensured if the analysis entity is integrated in the communication unit, or is accommodated on an external server, or is integrated in the additional communication unit.

Further advantages and embodiments of the invention are derived from the description and the enclosed drawings.

The invention is illustrated schematically in the drawings by reference to exemplary embodiments, which are particularly advantageous but not to be understood as limiting, and described in detail in the following with reference to the drawing.

Other features which are considered as characteristic for the invention are set forth in the appended claims.

Although the invention is illustrated and described herein as embodied in a communication system for text-based communications, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURE

The single FIGURE of the drawing is an illustration showing an exemplary embodiment of a communication system according to the invention.

### DETAILED DESCRIPTION OF THE INVENTION

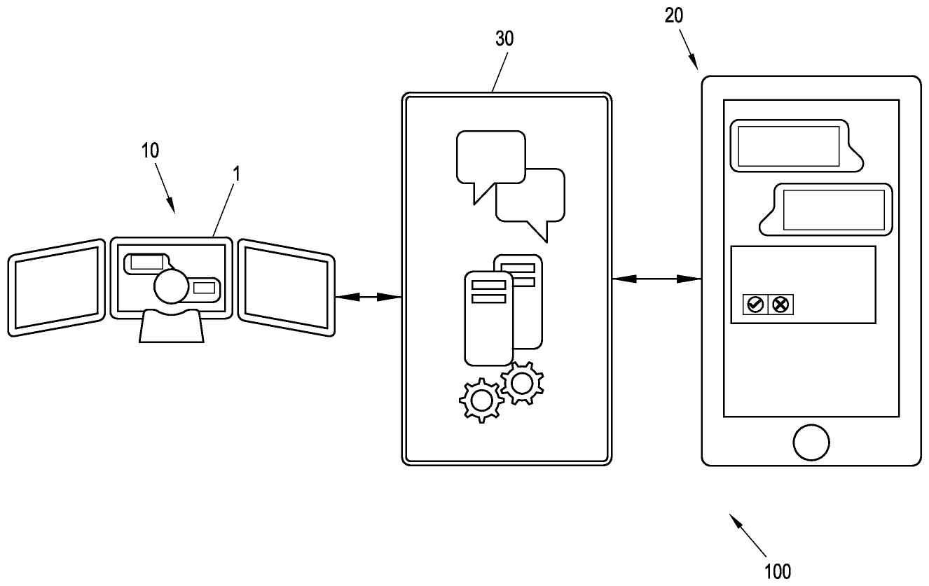

Referring now to the figures of the drawings in detail and first, particularly to FIG. 1 thereof, there is shown an exemplary embodiment of a communication system 100 according to the invention, which is used in connection with text-based emergency call communication. The FIGURE shows an operator's workstation 10 which comprises a communication unit. Such an operator's workstation 10 can be used, for example, in an emergency control center belonging to the police, rescue service, fire brigade or the like. The operator's workstation 10 in the exemplary embodiment is operated by an operator of a rescue service control center as the first user.

The communication unit of the operator's workstation 10 has a communication interface via which emergency calls are received in the form of chat text messages by an emergency caller as a second user and responses to such emergency calls, also in the form of chat text messages, can be sent.

Furthermore, the communication unit contains an input unit such as a touchscreen or, in the simplest case, a keyboard, via which the operator can input chat text messages to an emergency caller. The communication unit also contains a display unit 1 in the form of a screen on which the incoming chat text messages from the emergency caller on the operator's workstation 10, as well as the chat text messages that the operator enters, are displayed. Of course, a communication unit can optionally comprise multiple display units or multiple screens.

In the exemplary embodiment, an emergency call in the form of a chat text message is issued by an emergency caller who is witness to an accident. The emergency caller uses an additional communication unit for this, which in the exemplary embodiment is a mobile device in the form of a smartphone 20.

From the smartphone 20 a chat application can be invoked, via which incoming emergency calls can be sent as chat text messages to the operator or the communication unit of the operator's workstation 10. In the exemplary embodiment, the chat application is installed on the smartphone 20 of the emergency caller. Alternatively, however, the chat application can also be deployed on an external server that can be accessed from the smartphone 20. The chat application is programmed or designed to display graphical user interfaces directly in the chat or chat history on the smartphone.

The mobile device has similar components to the communication unit, namely an additional communication interface, via which emergency calls in the form of chat text messages are sent to the operator or the communication unit of the operator's workstation 10 and responses in the form of chat text messages can be received by the operator or the communication unit of the operator's workstation 10.

The touchscreen of the smartphone 20 acts as an input unit, via which the emergency caller can input chat text messages, and as a display unit, on which the emergency caller can be shown chat text messages entered and received by them in the form of a chat or chat history.

An analysis entity 30 is connected between the communication interface of the operator's workstation 10 and the additional communication interface of the smartphone 20. In the exemplary embodiment, the analysis entity 30 is located on an external server. However, the analysis entity 30 can optionally also be integrated in the communication unit or the further communication unit.

The analysis entity 30 accesses and analyzes the chat text messages entered via the input device. Different approaches, such as the use of text recognition methods or the use of artificial intelligence, can be considered for this analysis. For a text analysis, a large number of ready-made program components are known, which can be implemented in the analysis entity 30.

Based on the textual analysis of the chat text message created by the operator, the analysis entity 30 adds metadata to the chat text message entered by the operator before the chat text message is sent to the additional communication interface of the smartphone 20. In the exemplary embodiment, this metadata consists of an identifier that identifies one or more graphical user interface(s) that the chat application on the smartphone 20 should display in the chat or chat history.

In the exemplary embodiment, this identifier is a simple alphanumeric string or ID, which when received causes the chat application on the smartphone 20 to display at least one associated graphical user interface or GUI component, i.e. to display at least one graphical user interface, the identifier of which corresponds to the received identifier.

For this purpose, in the exemplary embodiment the graphical user interfaces or GUI components are already hard-coded with their corresponding identifying ID in the emergency caller's chat application or on the mobile device. This solution is simple to implement and new GUI components can be added by modifying or extending the chat application.

In addition, or as an alternative to, metadata in the form of an identifier, the analysis entity 30 can add metadata in the form of a software component to the input chat text message. This software component can be, for example, a direct description of the graphical user interface or GUI component to be displayed, for example as HTML. The chat application then displays a graphical user interface corresponding to this program code when the software component is received. In this case, the chat application belonging to the emergency caller or on the mobile device is equipped with the functionality to display this description.

As previously mentioned, the emergency caller uses a smartphone 20 to make an emergency call in the form of a chat text message via the chat application, as the caller has witnessed an accident. The emergency caller enters the chat text message “We need an ambulance, a man has been injured in an accident”.

The text-based emergency call from the emergency caller is received by the communication interface of the operator's workstation 10 in the rescue control center and presented or displayed on the display unit 1 of the operator's workstation 10. Since the accident victim has been injured, the operator attempts to obtain more detailed information on whether or how seriously the victim is injured, in order to assist the emergency caller in providing first aid.

Therefore, the operator enters the chat text message “Is the person conscious?” via the input device. The analysis entity 30, which is connected between the communication interface of the operator's workstation 10 and the additional communication interface of the smartphone 20, recognizes the message input by the operator and analyzes the text. Based on this analysis, the analysis entity 30 determines that this is a Yes/No question and that an appropriate graphical user interface should be displayed to the emergency caller that allows them to enter “Yes” or “No” in response.

Accordingly, the analysis entity adds metadata to the message from the operator to the emergency caller in the form of the alphanumeric identifier 1X9Z28, which corresponds to a GUI widget that allows the emergency caller to tap “Yes” or “No” on the screen of their smartphone 20, thus answering the operator's question without needing to enter a chat text message.

Subsequently, the chat text message including the added metadata is transmitted from the communication interface of the operator's workstation 10 to the additional communication interface of the smartphone 20 and processed by the chat application. The chat application displays the operator's question in the chat or chat history and the graphical user interface corresponding to the transmitted identifier, which is the Yes/No GUI widget, shown in the FIGURE. The answer option “Yes” in the exemplary embodiment is characterized by a key in the form of a circle containing a check mark, while “No” is characterized by a key in the form of a circle containing an X.

The processing of the interaction of the emergency caller with the GUI widget in the exemplary embodiment is handled by the chat application on the additional communication unit. The chat application recognizes an interaction with the GUI widget in the chat performed by the emergency caller via the additional input unit, i.e. the touchscreen, converts this interaction into a corresponding chat text message and transmits it to the communication unit of the operator's workstation 10.

The interaction of the emergency caller with the GUI widget, i.e. which button they press in the Yes/No GUI widget in the exemplary embodiment, is thus transmitted to the operator. In the exemplary embodiment this takes place in the form of a simple text message, i.e. since the emergency caller has pressed the “Yes” key, the chat text message “YES” is transmitted to the operator.

In addition or alternatively, it is also possible to send metadata as a response instead of or in addition to the chat text message. In this case, the analysis entity 30 handles the processing of the interaction with the graphical user interface performed by the emergency caller in the chat on the additional communication unit. The analysis entity 30 then generates metadata corresponding to the response of the emergency caller and transmits this to the operator's workstation 10 or the control center, which is displayed there accordingly.

After the operator is shown the chat text message “YES” on the display unit 1 of the operator's workstation 10, they enter the question “Where is the person injured?” as the next chat text message. The analysis entity 30 recognizes the message input by the operator and, based on the analysis of the text, determines that the emergency caller should be shown a graphical user interface on which they can select bodily regions.

The analysis entity 30 accordingly adds metadata in the form of the alphanumeric identifier 5A345BB to the message from the operator to the emergency caller, corresponding to a GUI widget showing a schematic representation of a person, on which the emergency caller can select body parts by tapping on the screen of their smartphone 20.

The chat text message including the added metadata is then transmitted to the further communication interface of the smartphone 20 and the chat application displays the GUI widget corresponding to the metadata in the chat with a schematic illustration of a person. The emergency caller touches the left arm of the person depicted on the input unit or the touchscreen of their smartphone 20 and enters the chat text message “He is bleeding”.

Again, the interaction of the emergency caller with the GUI widget is transmitted to the operator. The chat application recognizes the interaction with the GUI widget in the chat performed by the emergency caller via the touchscreen, converts this interaction into a corresponding chat text message “LEFT ARM” and transmits this to the communication unit of the operator's workstation 10.

In the exemplary embodiment, metadata is sent from the analysis entity 30 as a response in addition to the chat text message. The analysis entity 30 processes the interaction with the graphical user interface performed by the emergency caller in the chat on the additional communication unit and generates metadata in the form of the alphanumeric identifier 5A345BBLA as a response to the operator and transmits this to the operator's workstation 10 or to the control center. A schematic representation of a person with the left arm highlighted is displayed on the display unit 1 of the operator's workstation 10.

For this purpose, the communication unit or the operator's workstation 10 can optionally have a chat application that can process metadata transmitted by the analysis entity 30 and display it in the chat on the display unit 1 for the operator. However, this is optional and it is sufficient for the operation of a communication system 100 according to the invention if chat text messages are displayed as simple text on the communication unit or the operator's workstation 10, or if a chat application is installed or can be invoked by the communication unit, which displays chat text messages for the operator.

After the chat text messages “LEFT ARM” and “He is bleeding” and the schematic representation of a person with markings is displayed to the operator on the display unit 1 of the operator's workstation 10, the operator enters the words “I am sending a video showing how to stop the bleeding” as the next chat text message. The analysis entity 30 recognizes the message input by the operator and, based on the analysis of the text, determines that the emergency caller should be shown a video which explains the correct bandaging technique.

The analysis entity 30 adds metadata in the form of the alphanumeric identifier 1CVVV5L to the operator's message to the emergency caller, corresponding to a graphical user interface which displays a corresponding explanatory video in the emergency caller's chat.

In this way, it is advantageously possible for the operator using a communication system 100 according to the invention to receive specific information and give instructions in the event that an emergency caller issues a text-based emergency call to the emergency control center. Other types of graphical user interfaces or GUI widgets that can be displayed in the chat on the additional communication unit include, for example, the display of:
a date and/or time selection,
a range of numbers (1, 2, 3, n), for example to ask for the number of injured persons,
a more/less question,
a map for manually selecting a position, which is particularly advantageous if, for example, the GPS function of the additional communication unit of the emergency caller has failed or the additional communication unit does not yet have a GPS function,
graphical user interfaces that do not allow user interaction, such as displaying images, pictograms, videos or outputting audio files.

Another advantage of the application of a communication system 100 according to the invention is that a partial automation, for example, of an emergency call is made possible. Many emergency control centers, e.g. rescue services, process a pre-defined list of questions during an emergency call. The answers given by the emergency caller determine the next questions asked, i.e. in a kind of decision tree. Many of these questions can be displayed using graphical interfaces such as GUI widgets. In this way, the emergency control center can automatically determine the most important information even before the operator actually takes over the text-based emergency call.

In this case, the analysis entity 30 analyzes not only the chat text messages entered by the operator on the communication unit via the input unit, but also the chat text messages entered by the emergency caller via the additional input unit. Based on this analysis, the analysis entity 30 selects chat text messages stored in a memory, for example from a list of questions, and sends them to the additional communication unit of the emergency caller. In addition to or instead of chat text messages, the analysis entity 30 can of course also select graphical user interfaces to be displayed on the additional communication unit for the emergency caller and transmit the corresponding metadata to the additional communication unit. For example, the memory in question may be accommodated in the analysis entity 30 and/or in the first communication unit.

Although the described exemplary embodiment further explains the operation of a communication system 100 according to the invention in connection with text-based emergency communication, a communication system 100 according to the invention can also be used in other areas of application.

Thus, a communication system 100 according to the invention can be advantageously used, for example, in connection with technical service or support requests, in which support is offered by a call center or help desk to deal with technical problems with complex laboratory equipment or even common household appliances, such as washing machines and the like. Again, in this context it is desirable if a customer service representative as the first user is able to request specific information from a device user as the second user about the device type or the technical problem that has occurred.

It is also possible, of course, for the transmitted metadata optionally to identify not just a single, but multiple graphical user interfaces, such as GUI widgets which are to be displayed to the user. For example, in connection with support or service requests, in response to the request by the first user or customer service representative “Is the device type the LAVA50?”, metadata can be transmitted that causes the chat application to display a Yes/No question on the additional communications unit of the second user, and a pictogram showing where the type number can be found on that device.

Furthermore, it is optionally possible that when a chat text message is entered via the input unit in the chat, the first user him/herself selects graphical user interfaces to be displayed on the additional communication unit for the second user. For example, the first user chooses a desired graphical user interface from graphical user interfaces, such as GUI widgets, stored in a memory with the associated metadata, and the analysis entity then adds metadata corresponding to the selected graphical user interface to the chat text message entered by the first user via the input unit. For example, the memory can be located in or included in the communication unit and/or the analysis entity.

For example, in connection with support or service requests, in response to the information given by the first user or service employee “For your device type, the USB port is to be found on the left at the rear of the device”, the first user can select a graphical user interface from the memory that shows a pictogram of the location of the ports on the device and the corresponding metadata will then be transmitted by the analysis entity, which causes the chat application on the second user's additional communication unit to display the pictogram.

1. A communication system for text-based communication, comprising:
a communication unit and an additional communication unit, said communication unit, containing:
at least one communication interface configured to receive chat text messages from said additional communication unit and to send incoming said chat text messages to said additional communication unit;
an input unit allowing a first user to input the chat text messages; and
a display unit, on which the chat text messages received from said at least one communication interface and the chat text messages input via said input unit can be displayed as chat;
said additional communication unit, containing:
at least one additional communication interface configured to receive the chat text messages from said communication unit and to send incoming said chat text messages;
an additional input unit allowing a second user to input the chat text messages;
an additional display unit, on which the chat text messages received from said additional communication interface and the chat text messages input via said additional input unit can be displayed as said chat; and
a chat application being invoked from said additional communication unit, wherein the chat text messages being issued via the chat application to said communication unit, and wherein the chat application is configured to display graphical user interfaces in the chat on said additional communication unit; and
an analysis entity connected between said at least one communication interface and said at least one additional communication interface, wherein said analysis entity is configured to analyze the chat text messages input via said input unit and based on an analysis, to add metadata to an input said chat text message before forwarding the chat text messages to said additional communication interface, wherein the chat application is configured to display a graphical user interface corresponding to the metadata upon receiving the metadata.

2. The communication system according to claim 1, wherein said analysis entity is configured to add the metadata in a form of an identifier to the input chat text message before forwarding it to said additional communication interface, wherein the identifier identifies the graphical user interface to be displayed on said additional communication unit by the chat application, wherein in the chat application at least one graphical user interface is stored with its associated identifying identifier and wherein the chat application is configured, upon receiving an identifier, to display the at least one graphical user interface, the identifier of which corresponds to the identifier received.

3. The communication system according to claim 1, wherein said analysis entity is configured to add the metadata in a form of a software component to the input chat text message before forwarding it to said additional communication interface, wherein the chat application is configured to display a corresponding graphical user interface on receiving the software component.

4. The communication system according to claim 1, wherein:
said additional communication unit is a mobile device;
the chat application is invoked from said communication unit;
the chat text messages are sent to said additional communication unit via the chat application; and
the chat application is configured to display the graphical user interfaces in the chat.

5. The communication system according to claim 1, wherein:
the text-based communication is a text-based emergency communication;
said communication unit is included in an operator workstation (10) for an emergency control center;
said at least one communication interface is configured to receive emergency calls in a form of the chat text messages from said additional communication unit and to send incoming said chat text messages to said additional communication unit;
said input unit allows an operator as the first user to input the chat text messages to the second user; and
the chat text messages received from said at least one communication interface and the chat text messages input by the operator via said input unit are displayed on said display unit.

6. The communication system according to claim 5, wherein:
said additional communication unit is a mobile device;
the chat application being invoked from said mobile device allows the emergency calls in a form of the chat text message being issued to the emergency control center; and
said mobile device contains said at least one additional communication interface, which is configured to send the emergency calls in a form of the input chat text messages to said communication unit of the operator workstation and to receive the chat text messages from said communication unit of the operator workstation.

7. The communication system according to claim 1, wherein said analysis entity is configured to analyze the chat text messages input via said additional input unit and, based on an analysis, to select the chat text messages stored in a memory of said analysis entity and/or in a memory of said first communication unit and/or the metadata of said graphical user interfaces to be displayed on said additional communication unit and to send the chat text messages and the metadata to said additional communication unit.

8. The communication system according to claim 1, wherein said graphical user interfaces to be displayed by the chat application are graphical user interface (GUI) widgets.

9. The communication system according to claim 1, wherein said graphical user interface contains at least one of the following elements:
a yes/no question;
a date and/or time selection;
a numeric range;
a more/less question;
a geographical map for manually selecting a position via said additional input unit;
a schematic representation of a person for selecting a body part via said additional input unit;
a picture;
a pictogram;
a video; and
an audio file for output via a speaker of said additional communication unit.

10. The communication system according to claim 1, wherein said analysis entity is configured to detect an interaction with said graphical user interface performed by the second user in the chat via said additional input unit and to perform the following actions on the interaction with said graphical user interface:
convert the interaction into a chat text message corresponding to the interaction and transmit the chat text message to said communication unit; and/or
generate the metadata corresponding to the interaction and transmit the metadata to said communication unit.

11. The communication system according to claim 1, wherein the chat application is configured to detect an interaction with the graphical user interface performed by the second user in the chat via said additional input unit and to convert the interaction with the graphical user interface into a chat text message corresponding to the interaction and transmit the chat text message to said communication unit.

12. The communication system according to claim 4, wherein the chat application of said communication unit is configured to process the metadata transmitted by said analysis entity and to display it on said display unit for the first user.

13. The communication system according to claim 1, wherein:
said communication unit and/or said analysis entity contains a memory;
said graphical user interfaces with their associated identifying said meta are stored in said memory;
when a chat text message is input via said input unit by the first user, the graphical user interfaces stored in said memory are selectable; and
said analysis entity is configured, when an at least one graphical user interface is selected via said input unit, to add the metadata to the input chat text message corresponding to the at least one graphical user interface selected.

14. The communication system according to claim 1, wherein said analysis entity is:
integrated in said communication unit; or
accommodated on an external server; or
integrated in said additional communication unit.

15. The communication system according to claim 4, wherein:
the mobile device is a smartphone or tablet; and/or
the chat application is installed on said communication unit.

16. The communication system according to claim 6, wherein said mobile device is a smartphone or tablet.

17. The communication system according to claim 7, wherein the chat text messages stored in said memory of said analysis entity are stored said chat text messages from a question list.

18. The communication system according to claim 9, wherein said graphical user interfaces are graphical user interface widgets.

19. The communication system according to claim 13, wherein:
said graphical user interfaces are graphical user interface widgets and the associated identifying said metadata is an identifier; and
said analysis entity is configured, when the at least one graphical user interface is selected via said input unit, to add to the input chat text message an identifier and/or software component which corresponds to the graphical user interface selected.
